(19) United States
(12) Patent Application Publication
(10) Pub. No.: US 2005/0138158 A1
(43) Pub. Date: Jun. 23, 2005

(54) Software download method and system

(75) Inventors: David Carroll Challener, Raleigh, NC (US); Richard W. Cheston, Morrisville, NC (US); Daryl Carvis Cromer, Apex, NC (US); Howard Jeffrey Locker, Cary, NC (US); Rod David Waltermann, Rougemont, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/744,618

(22) Filed: Dec. 23, 2003

(51) Int. Cl. G06F 15/173

(52) U.S. Cl. 709/223

(57) ABSTRACT

A method and system for downloading software according to an identity of a user. Upon booting up a client computer, the user is automatically directed to a deployment server, which contains a listing of software to which the user is authorized to download and use. The directions to the deployment server are provided by a domain name server, or a domain controller. The software initially loaded onto the client computer is minimal, such that it is easily appended with additional features and programs.

### BACKGROUND OF THE INVENTION

1. Technical Field

The present invention relates in general to the field of computers, and in particular to network based computers. Still more particularly, the present invention relates to a method and system for a automatically downloading software within an enterprise.

2. Description of the Related Art

Current personal computers typically come preloaded with a suite of software. For example, nearly all will come preloaded with an Operating System (OS), such as Windows® by Microsoft® Corporation. Further, most will come preloaded with other software, including an Internet browser, a bare-bones word processor and spread sheet program, a few games, utility programs, et al. Such computers pose several problems for enterprises such as corporations, governmental agencies, schools, etc.

One problem is that the preloaded software that the enterprise wishes to keep, such as the OS, is often not configured properly for the enterprises' operations. That is, preloaded OS's are often configured for an “average” user, which essentially means that it is not properly configured for anyone. Another problem with preloaded software is that it includes software that the enterprise does not wish to keep, such as games, administrator access, and other programs that are not appropriate for many users in the enterprise.

Thus, most enterprises develop their own customized images (set of software) for the entire enterprise. First, unwanted preloaded programs or features are removed. Then, an Information Technology (IT) department loads programs that are used by all areas of the enterprise. Next, the IT department further modifies the customized images for each user or department, followed by an installation of additional software programs for that user/department, such as specialized accounting programs for the billing department, drawing programs for the engineering department, etc. These additions and/or modifications are usually done while the personal computer is physically at the IT department location, and the configured personal computer is then sent to the user/department, who plugs the personal computer into a network and to begin work.

Such a system obviously is very time consuming, since each personal computer must be manually configured with the requisite programs and software settings. What is needed, therefore, is a method and system that allows a personal computer to be imaged in a customized manner, with a minimal amount of discarding of software. Preferably, such as method should automatically configure the personal computer according to characteristics, needs, and authorization of specific users as defined by the enterprise.

### SUMMARY OF THE INVENTION

The present invention is directed to a method and system for downloading software according to an identity of a user. Upon booting up a client computer, the user is automatically directed to a deployment server, which contains a listing of software to which the user is authorized to download and use. The directions to the deployment server are provided by a domain name server, or a domain controller. The software initially loaded onto the client computer is minimal, such that it is easily appended with additional features and programs.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a network under which the present invention is operable;

FIG. 2 illustrates a block diagram of a client computer and/or a deployment server;

FIG. 3 depicts steps taken to direct the client computer to the deployment server via a specialized Dynamic Host Configuration Protocol (DHCP) server and a Domain Name Server (DNS); and

FIG. 4 is a flow chart describing the client computer accessing the deployment server via a Domain Controller.

### DETAILED DESCRIPTION OF A PREFERRED EMBODIMENT

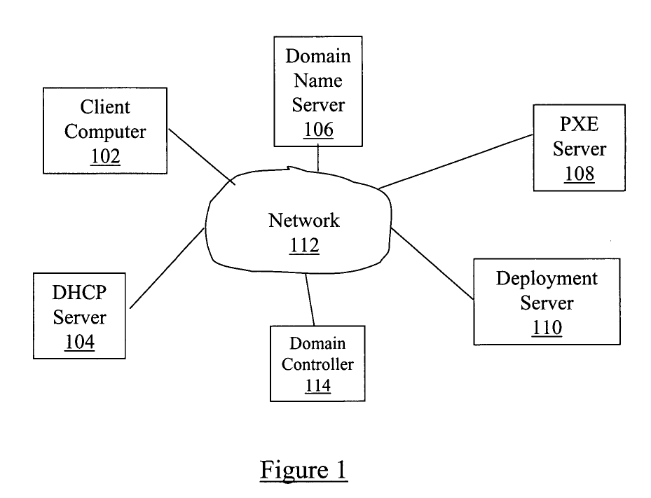

With reference now to the figures, and in particular to FIG. 1, there is depicted a block diagram of a network 112 as used by the present invention. Connected to network 112 is a client computer 102, which receives a tailored software package and setup under the present invention. Also connected to network 112 is a Dynamic Host Configuration Protocol (DHCP) server 104, a Domain Name Server (DNS) 106, a Pre-boot eXecution Environment (PXE) server 108, a deployment server 110, and a domain controller 114. Details of the function of these systems attached to network 112 are provided below.

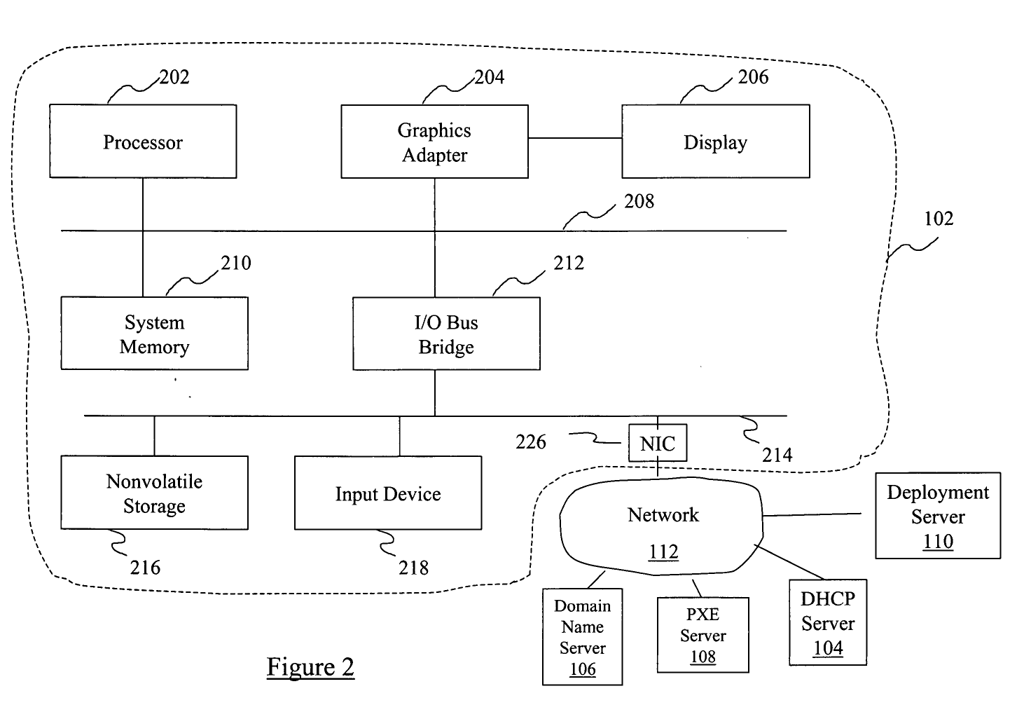

With reference now to FIG. 2, there is depicted an exemplary block diagram of client computer 102. Client computer 102 includes a processor 202, which is connected to a system bus 208. In the exemplary embodiment, client computer 102 includes a graphics adapter 204 also connected to system bus 208, receiving information for a display 206.

Also connected to system bus 208 are system memory 210 and input/output (I/O) bus bridge 212. I/O bus bridge 212 couples an I/O bus 214 to system bus 208, relaying and/or transforming data transactions from one bus to the other. Peripheral devices such as nonvolatile storage 216, which may be a hard disk drive, floppy drive, a compact disk read-only memory (CD-ROM), a digital video disk (DVD) drive, or the like, and an input device 218, which may include a conventional mouse, a trackball, or the like, is connected to I/O bus 214. Client computer 102 connects with network 112 via a network interface card (NIC) 226 as shown.

Network 112 may be the Internet, an enterprise confined intranet, an extranet, or any other network system known to those skilled in the art of computers. In a preferred embodiment, however, network 112 is an enterprise wide Local Area Network (LAN) within a firewall.

The exemplary embodiment shown in FIG. 2 is provided solely for the purposes of explaining the invention and those skilled in the art will recognize that numerous variations are possible, both in form and function. For instance, client computer 102 might also include a sound card and audio speakers, and numerous other optional components. All such variations are believed to be within the spirit and scope of the present invention.

The block diagram of FIG. 2 for client computer 102 is also an appropriate representation of hardware used by deployment server 110, which for purposes of brevity will not be re-iterated.

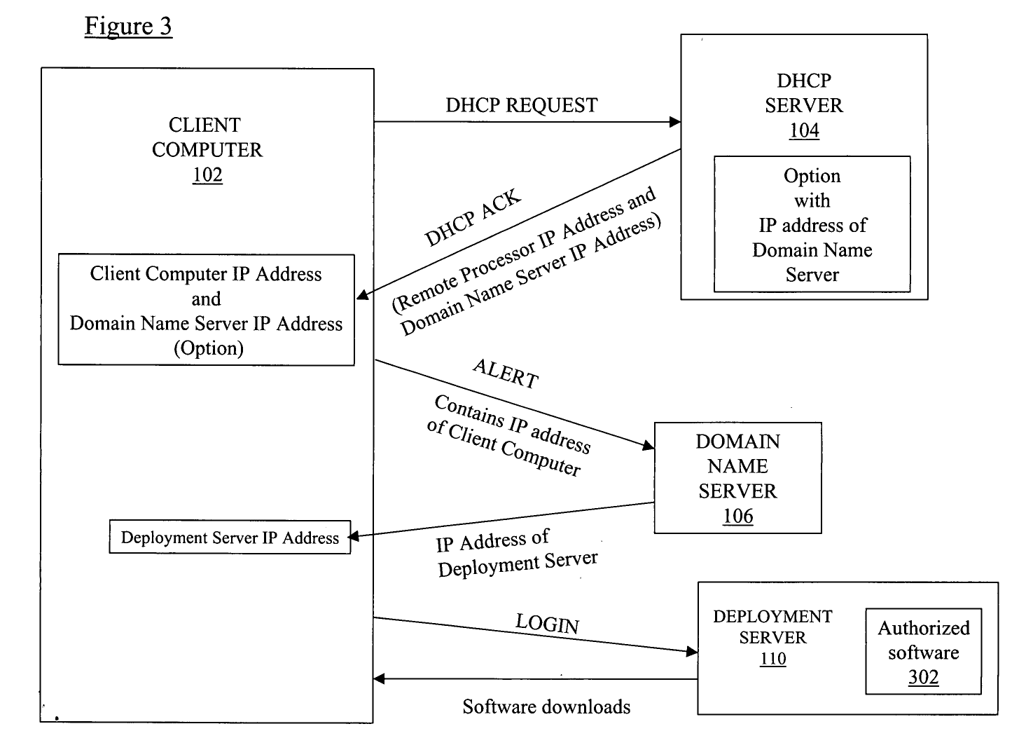

Referring now to FIG. 3, there is depicted a block diagram of a boot-process and software download between client computer 102 and DHCP server 104, DNS 106, and deployment server 110. First, client computer 102 sends a DHCP REQUEST to a DHCP server 104. That is, client computer 102 does not follow traditional DHCP protocol by first broadcasting a DHCP DISCOVER message, to which any DHCP server would respond with a DHCP OFFER message offering an Internet Protocol (IP) address lease. Rather, client computer is pre-programmed to send a DHCP REQUEST message to a specified DHCP server, namely DHCP server 104.

In an alternate embodiment of the present invention, DHCP REQUEST is broadcast to all DHCP servers on a Local Area Network (LAN). However, all of the DHCP servers are pre-configured with a list of client computers to which they are authorized to respond. The DHCP REQUEST continues to be broadcast on the LAN until DHCP server 104 receives the DHCP REQUEST. DHCP Server 104 has been pre-configured to compare the Media Access Controller (MAC) address or some other hardware identifier of client computer 102 with a list of client computers on the LAN. Since the MAC address of client computer is not on the list of existing client computers on the LAN, DHCP server 104 sends the DHCP ACK message containing the Option described in the next paragraph.

DHCP server 104 returns to client computer 102 a DHCP ACK packet, which includes both the new IP address being assigned to client computer 102 as well as special “Option” data, which includes the IP address of only DNS 106.

When the client computer 102 receives the DHCP ACK packet, special code stored in client computer 102 searches the DHCP ACK packet for the special Option data, which includes the IP address of DNS 106. Client computer 102 stores the Option data as an Alert destination. Responsive to detecting the Option data, the client computer 102 then sends its newly assigned IP address to DNS 106 in an ALERT packet. DNS 106 receives the ALERT packet, and then returns to client computer 102 the IP address of deployment server 110. Client computer 102 then contacts deployment server 110 and the user logs in. Upon the user logging in, deployment server 110 returns the authorized software programs 302 to client computer 102 by running an update/configure script. That is, deployment server 110 reads the name (or group or other identifier) of the user logging in, and then returns to client computer 102 only the authorized software for that user.

In an alternate embodiment of the present invention, the user of client computer 102 can be told in person which deployment server is his authorized deployment server 110. That is, an IT manager can call the user, and tell him to type in the IP address of deployment server using his browser. This action will take the user directly to deployment server 110, allowing the user to log in and thus permit client computer 102 to receive the authorized software downloads stores the information about the IP address assigned to remote management processor 306. This information includes the IP address itself, as well as the shelf life of the address and any special restrictions or features associated with the IP address.

In another preferred embodiment, client computer 102 can be custom configured using a domain controller, such as domain controller 114 depicted in FIG. 1. A domain controller uses a network operating system, such as Windows NT®. A domain is used to manage access to a set of network resources such as applications, storage devices, printers, etc. to a specified group of users. The user logs in to the domain server and, if approved, will have access to resources in the domain, as determined by the user database maintained in the domain server.

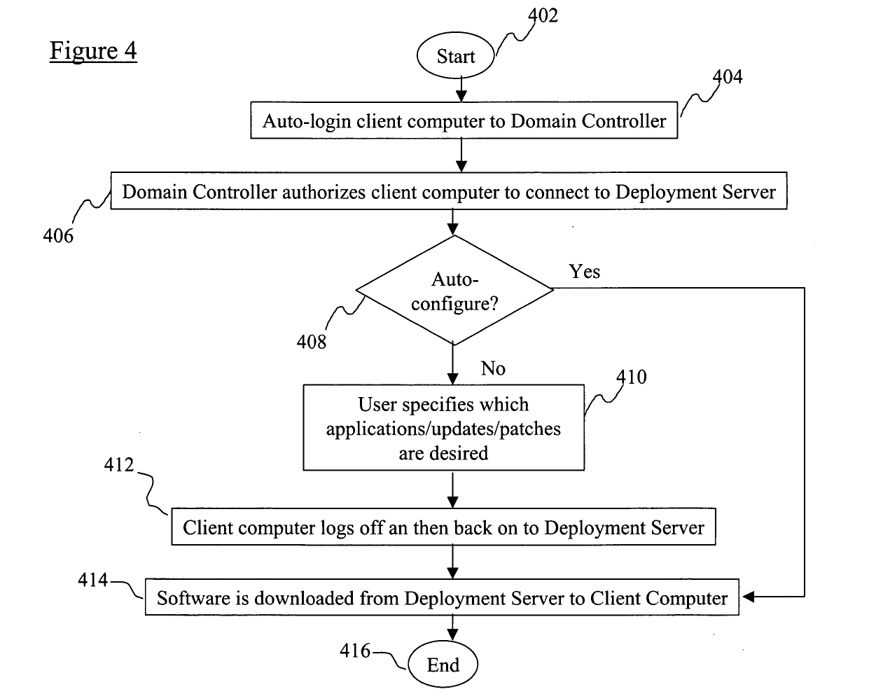

With reference now to FIG. 4, there is depicted a flow-chart describing the use of a domain server to download software to a client computer. First, the client computer auto-logs into the domain controller (blocks 402 and 404). The domain controller authorizes the client computer to contact the deployment server, and identifies the user of the client computer, as described above in FIG. 3 when logging into the deployment server 110.

To communicate with the domain controller, the client computer must have an IP address. Therefore, the client computer either has a permanent IP address, or has previously (not shown) obtained an IP lease from a DHCP Server.

A query is made after the auto-login with the domain controller as to whether the client computer is to be auto-configured (query block 408). That is, the user of the client computer may or may not have options as to which applications/settings/patches she wishes the client computer to have. If the user is to be allowed to make such decision/choices, then she selects which software is to be downloaded, within the options afforded her identity (block 410). The client computer is then logged off and back on (block 412). During the re-logging on, a log-on script gathers custom settings the user made from the website supported by the deployment server, and the software downloading process is then performed (block 414).

If the user is not allowed to decide which software is downloaded (answer to Auto-configure query block 408 is “Yes”), then the software is automatically downloaded, according to a listing of authorized software programs 302 in deployment server 110. In a preferred embodiment, the automatic loading of the software is directed by manipulating a pre-defined configuration program, such as “winbom.ini” in Windows® or using a program such as ImageUltra™ by IBM. Such pre-configuration programs a restored in the domain controller. When the client computer starts to boot up, the domain controller over-rides the pre-loaded pre-configuration program in the client computer, and replaces it with the pre-configuration program stored in the domain controller. This pre-configuration program, which is essentially a listing of programs available, is then run, defining which programs are to be downloaded from the deployment server.

Alternatively, the pre-configuration program can be under the direction an control of a PXE server, such as PXE server 108 shown in FIG. 1. The PXE server 108 can, during a Pre-OS boot, control the boot image to include a redirection of the client computer 102 to the deployment server 110, or else the PXE server 108 can redirect the client computer 102 to the domain name server 106 or a Domain Controller, as described in FIG. 4.

The present invention thus provides a method and system for downloading specific software to a client computer dependent on the user of the client computer. By logging into the deployment server under her personal identifier, which is preferably independent of a machine identifier for the client computer, the user can receive a download of software, including settings, flags, programs, and operating configurations, that are uniquely tailored to her needs.

Note that while the invention has been described for clarity purposes as downloading software directly from the deployment server, the authorized software list 302 shown in FIG. 3 may include links to other websites from which the authorized software may be downloaded. That is, the authorized software itself may be provided by the deployment server, or the deployment server may provide network links to other servers/websites from which the software may be downloaded onto the client computer.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

1. A method comprising:
receiving at a server a broadcasted a request for an Internet Protocol (IP) address from a client computer;
upon the server determining that the request for the IP address is from a client computer whose hardware identifier is unknown to the server, directing the client computer to a deployment server; and
downloading a pre-determined set of software from the deployment server to the client computer.

2. The method of claim 1, wherein the directing of the client computer to the deployment server is via an initial direction of the client computer to a domain name server, the domain name server then directing the client computer to the deployment server.

3. The method of claim 1, wherein the pre-determined set of software includes Operating System (OS) configurations.

4. The method of claim 1, wherein the pre-determined set of software includes application software.

5. A computer program product, residing on a computer usable medium, for providing software to a client computer, the computer program product comprising:
program code for receiving at a server a broadcasted a request for an Internet Protocol (IP) address from a client computer;
program code for, upon the server determining that the request for the IP address is from a client computer whose hardware identifier is unknown to the server, directing the client computer to a deployment server; and
program code for downloading a pre-determined set of software from the deployment server to the client computer.

6. The computer program product of claim 5, wherein the directing of the client computer to the deployment server is via an initial direction of the client computer to a domain name server, the domain name server then directing the client computer to the deployment server.

7. The computer program product of claim 5, wherein the pre-determined set of software includes Operating System (OS) configurations.

8. The computer program product of claim 5, wherein the pre-determined set of software includes application software.

9. A system comprising:
a client computer;
a Dynamic Host Configuration Protocol (DHCP) server in communication with the client computer, the DHCP server containing an Internet Protocol (IP) address of only one domain server, the domain server containing an IP address of only one deployment server; and
a deployment server containing the IP address of the only one deployment server stored in the domain server, the deployment server containing a list of software that is authorized to be downloaded to the client computer only upon an authorized user logging into the deployment server from the client computer.

10. The system of claim 9, wherein the list of software includes a link to another website for downloading the software.

11. The system of claim 9, wherein software corresponding with the list of software that is authorized to be downloaded to the client computer is stored in the deployment server.

12. The system of claim 9, wherein the list of software includes application software.

13. The system of claim 9, wherein the list of software includes OS settings.
